(19) United States
(12) Patent Application Publication
(10) Pub. No.: US 2017/0303052 A1
(43) Pub. Date: Oct. 19, 2017

(54) WEARABLE AUDITORY FEEDBACK DEVICE

(71) Applicant: Olive Devices LLC, Schaumburg, IL (US)

(72) Inventors: Renee Kakareka, Schaumburg, IL (US); Adrien Courdavault, Grenoble (FR)

(21) Appl. No.: 15/490,560

(22) Filed: Apr. 18, 2017

Related U.S. Application Data
(60) Provisional application No. 62/323,889, filed on Apr. 18, 2016.
(60) Provisional application No. 62/356,099, filed on Jun. 29, 2016.

(51) Int. Cl. H04R 25/00; G09B 21/00; G10L 15/26; G10L 21/10; G08B 6/00; H04R 3/00; H04S 7/00; H04W 4/00; G10L 21/06

(52) U.S. Cl. CPC H04R 25/30; H04R 25/407; G09B 21/009; G10L 15/265; G10L 21/10; H04S 7/40; H04R 25/554; G08B 6/00; H04R 3/005; H04R 2225/55; H04R 2430/21; G10L 2021/065; H04W 4/008

(57) ABSTRACT

A wearable auditory feedback device includes a frame, a plurality of microphone arrays, a plurality of feedback motors, and a processor. The frame is wearable on a user's head or neck. The microphone arrays are embedded in the frame on a left side, a right side, and a rear side with respect to the user. The feedback motors are also embedded in the frame on the left side, the right side, and the rear side with respect to the user. The processor is configured to receive a plurality of sound waves collected with the microphone arrays from a sound wave source, determine an originating direction of the sound waves, and activate a feedback motor on a side the frame corresponding to the originating direction.

### CROSS-REFERENCE TO RELATED APPLICATIONS

This application claims the benefit of U.S. Provisional Application Ser. No. 62/323,889, filed on Apr. 18, 2016, and U.S. Provisional Patent Application Ser. No. 62/356,099, filed on Jun. 29, 2016, each of which is incorporated herein by reference in its entirety.

### TECHNICAL FIELD

The present invention relates generally to a wearable auditory feedback device that comprises multiple microphones and one or more feedback mechanisms. Based on sounds gathered via the microphones, users are given tactile and/or visual feedback regarding the location and content of the source of the sounds.

### BACKGROUND

The Centers for Disease Control and Prevention estimates that, in the United States, 14.9% of children have some type of hearing loss in one or both ears. As a whole, 48 million Americans have some degree of hearing loss. In addition, 11% of Children in the United States have been diagnosed with Attention Deficit-Hyperactivity Disorder (ADHD). Other learning disabilities such as Auditory Processing Disorder, Language Processing Disorder, and Memory retention disabilities affect the speed and course of some aspects of child development.

Additionally, 90% of deaf children are born into hearing families who want their children in mainstreamed schools and “just like everyone else,” but they do not always have access, or the knowledge, to get their children the resources they need to succeed in a general education classroom. Revealed from deaf and hard of hearing interviews of those out of mainstreamed education, the deaf education system is one of the most important points in a child's life that requires improved communication.

Deaf students who do not receive intervention typically fall 1 to 4 grades behind according to the American Speech-Language-Hearing Association, while ADHD students typically fall 1 to 3 grades behind. Beyond educational development, this difficulty to communicate also hinders language and social development.

For millions of people around the world, a communication difficulty or learning disability hinders efficient development. There are over 360 million people around the world that are deaf according to the World Health Organization's (WHO) standards. 32 million of these individuals are children and only 10% of the need for hearing aids is supplied. These numbers also fail to include those that have recurring hearing loss or have a hearing loss that affects their communication but are not considered under the WHO's standards. The prevalence of hearing loss has more than doubled within the past 30 years and the hearing aid industry continues to grow at about 5% per year despite 90% of the market not being reached.

Most assistive communication devices for deaf and hard of hearing individuals are very large and cause many kids to become increasingly self-conscious and stop using their devices. Typically, this begins at about middle school age. A middle school deaf education teacher from the Northwest Suburban Special Education Organization (NSSEO) expressed that she does not have very many students using Assistive Learning Devices (ALDs) in her classes because most will stop using them after elementary school. Child Speech Therapists also made a similar comment for this age group in saying that the children become more self-conscious. Wearing a large device that amplifies sound causes a lot of self-esteem issues and without these devices, they are missing significant content.

Social development is very difficult for many children, and often poor emotional control is a consequence. Most deaf and hard of hearing students have the most trouble understanding conversations in groups. When reading lips, or using other microphone devices, a deaf or hard of hearing person has trouble trying to follow group conversations. Especially when paired with lip reading, it is more difficult to transition to a different person talking. When constantly trying to figure out who and what people are saying, auditory fatigue often starts to set in. This is when listening becomes so tiring that out of exhaustion, a person drifts into a ‘daydream’. Not only is this difficult in social situations but it also becomes a large problem at work and at school. Hearing aids attempt to address it by amplifying or transmitting sounds in a way that compensates for the difference in hearing from a person's left ear to their right. Sophisticated hearing aids have programming that changes the setting of the hearing aid for appropriate surroundings automatically but most have a button that can be pressed to manually set the programming to analyze the appropriate environmental sounds.

Common for children that wear hearing aids, although they amplify the sound, they often do not provide enough amplification for certain frequencies of letter sounds and words will be misinterpreted. A child may be sitting in class, listening to the lesson and hear a word that sounded like ‘taco’ but they know that this is not the correct word. Instead of listening to the remainder of the lesson, the child will think about what the word should have been and will miss a lot of important information. When many children miss pieces of conversations or lessons, they deem them unimportant and miss a huge component of the class. They do not know what they do not know.

Another issue with current service and devices is the lack of available products for people with temporary hearing losses. Due to a combination of stigma and money, most people with temporary losses, often from reoccurring ear infections, will not purchase an aid. For children, since the condition is not permanent, the parents feel they do not need to purchase hearing aids for their child. Therefore when an ear infection occurs, and they cannot hear their teacher, they will miss out on a bulk of their lessons.

Other strategies that are used for deaf and hard of hearing currently are Communication Access Real-time Translation (CART), which is a relay person typing verbal communication which is sent to a teleprompter or individual computer, accessory microphones or FM systems can be paired with hearing aids and cochlear implants so that sound goes from a specific person to their hearing device, closed captioning is used for TV programing and video. Also, sign language interpreters are used for the lesser amount of deaf and hard of hearing that learn sign language.

Outside, the inability to locate sound compromises safety. People have expressed feelings of anxiety due to the confusion and unknowing location of the source of a sound. There have also been experiences of getting hit by a car due to a hearing loss greater in one ear than in the other; the person was unable to hear the car coming on the side that their ear could not hear at that level of sound.

### SUMMARY

Embodiments of the present invention address and overcome one or more of the above shortcomings and drawbacks, by providing methods, systems, and apparatuses related to a wearable auditory feedback device. Briefly, the device described herein uses biomimetic principles of the human head, ears, and neck, paired with other sound processing techniques to locate the location of sound relative to the person using the wearable auditory feedback device. The device improves upon hearing aids, cochlear implants, captioning systems, headphone mics, and other microphone accessories by processing sounds in order to provide meaningful feedback to the user.

According to some embodiments of the present invention, a wearable auditory feedback device includes a frame, a plurality of microphone arrays, a plurality of feedback motors, and a processor. The frame is wearable on a user's head or neck. The microphone arrays and feedback motors are embedded in the frame on a left side, a right side, and a rear side with respect to the user. The processor is configured to receive a plurality of sound waves collected with the microphone arrays from a sound wave source, determine an originating direction of the sound waves, and activate a feedback motor on a side the frame corresponding to the originating direction.

In some embodiments, the processor in the aforementioned wearable auditory feedback device is further configured to estimate a distance to an originating source of the sound waves and select a vibration pattern based on the distance. The activation of the feedback motor vibrates the feedback motor according to the vibration pattern. The originating source of the sound waves may be estimated, for example, based on a plurality of locality cues corresponding to the sound waves comprising one or more of inter-aural time difference (ITD), an inter-aural intensity difference (IID), and beamforming results.

In some embodiments, the aforementioned wearable auditory feedback device further comprises a non-volatile computer readable medium which stores a plurality of settings for configuring one or more of the plurality of microphone arrays, the plurality of feedback motors, or the processor. In these embodiments, the processor may be further configured to receive new settings via a network connection (e.g., a Bluetooth or Tele-coil network connection) to a hearing device (e.g., a hearing aid or cochlear implant). Once received, the new settings can be stored on the non-volatile computer readable medium. The settings may include, for example, a setting which filters the plurality of sound waves collected with the microphone arrays to attenuate sound wave frequencies outside a range of frequencies corresponding to human voices. Additionally, in some embodiments, the processor is further configured to transmit the filtered sound waves via the network connection to a hearing device.

In another aspect of the present invention, as described in some embodiments, a wearable auditory feedback device comprises a frame, a display, a plurality of microphone arrays, and a processor. The frame is wearable on a user's head or neck. The display is connected to the frame and viewable by the user as the wearable auditory feedback device is worn. The microphone arrays are embedded in the frame on a left side, a right side, and a rear side with respect to the user. The processor is configured to receive a plurality of sound waves collected with the microphone arrays, determine an originating direction of the sound waves with respect to the user, and provide a visual indication of the originating direction on the display. The wearable auditory feedback device may further include an orientation sensor (e.g., gyroscope or accelerometer) configured to determine updates to the user's orientation with respect to the sound wave source. The processor may be further configured to determine an updated originating direction of the sound waves with respect to the user based on the updates to the user's orientation. Then, the processor can update the visual indication of the originating direction on the display.

In some embodiments, the processor in the wearable auditory feedback device is further configured to translate speech in the sound waves to text and present the text on the display. The text may be presented, for example, on a portion of the display corresponding to the originating direction. In some embodiments, the processor is further configured to determine an updated originating direction of the sound waves with respect to the user, and update placement of the text on the display based on the updated originating direction. In some embodiments, the processor is configured to present the text on an external display connected to the wearable auditory feedback device via one or more networks.

According to other embodiments of the present invention, a wearable auditory feedback device comprises a frame wearable on a user's head or neck; a network interface to an external computing device comprising a display; a plurality of microphone arrays embedded in the frame on a left side, a right side, and a rear side with respect to the user; and a processor. The processor is configured to receive a plurality of sound waves collected with the microphone arrays, determine an originating direction of the sound waves with respect to the user, and provide a visual indication of the originating direction on the display of external computing device via the network interface.

Additional features and advantages of the invention will be made apparent from the following detailed description of illustrative embodiments that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there are shown in the drawings embodiments that are presently preferred, it being understood, however, that the invention is not limited to the specific instrumentalities disclosed. Included in the drawings are the following figures:

FIG. 1 illustrate a top view of a wearable auditory feedback device, according to some embodiments;

FIG. 2 illustrate example dimensions of wearable auditory feedback device, according to some embodiments;

FIG. 3 illustrates the effect of a head shadow on the wearable auditory feedback device when the device worn around a user's neck, according to some embodiments;

FIG. 4 shows a circuit design that may be used in implementing the wearable auditory feedback device, according to some embodiments;

FIG. 5 illustrates a sound processing algorithm utilized in some embodiments of the present invention;

FIG. 6 provides an illustration of beamforming, as implemented in some embodiments;

FIG. 7 provides an exploded view of the wearable auditory feedback device incorporated into a smart glasses design, according to some embodiments;

FIG. 8 provides a second exploded view of the wearable auditory feedback device incorporated into a smart glasses design, according to some embodiments;

FIG. 9 provides an example head related transfer function and how the combination of sound processing techniques is used with sounds sourced from some different areas in a space, according to some embodiments; and

FIG. 10 illustrates an example of how captioning of speech can be displayed by wearable auditory feedback device when the device is incorporated into a heads up display, according to some embodiments.

### DETAILED DESCRIPTION

Systems, methods, and apparatuses are described herein which relate generally to a wearable auditory feedback device that detects the location of sound through multiple microphone arrays. The sound location is converted into useful information to display in different forms of media. These media include, but are not limited to, tactile vibration, computer display, smart phone display, or tablet display. Multimedia displays include, but are not limited to, computer screens, heads up displays, mobile phones and tablets, or smart watches.

The wearable auditory feedback device described herein provides better communication and information retention for individuals with hearing impairments, vision impairments, and attention difficulties. For example, locating sounds assists in visual communication often used by people with hearing impairments such as lip reading, written word, sign language, or other visual gestures. As a tactile display, the wearable auditory device can stand alone and locate the location of sound. This means there is no additional device needed to get the information required to locate sound. When an important sound is detected a vibration will indicate on a specific part of the neck if that sound was coming from left, right, and possibly behind. The location of vibration will indicate the direction the user needs to turn in order to see who is speaking.

An indication of direction could also assist persons with attention issues to remain engaged in conversations or their environment. A small vibration that is received when someone is speaking could alert the person with an attention issue to follow the sound and prevent their minds from drifting off. Additionally, constant vibration has proved to help people with Autism Spectrum Disorder and Attention Deficit Disorder to maintain their attention. Therefore, a subtle vibration when their attention is needed could help those that benefit from sensory stimulation.

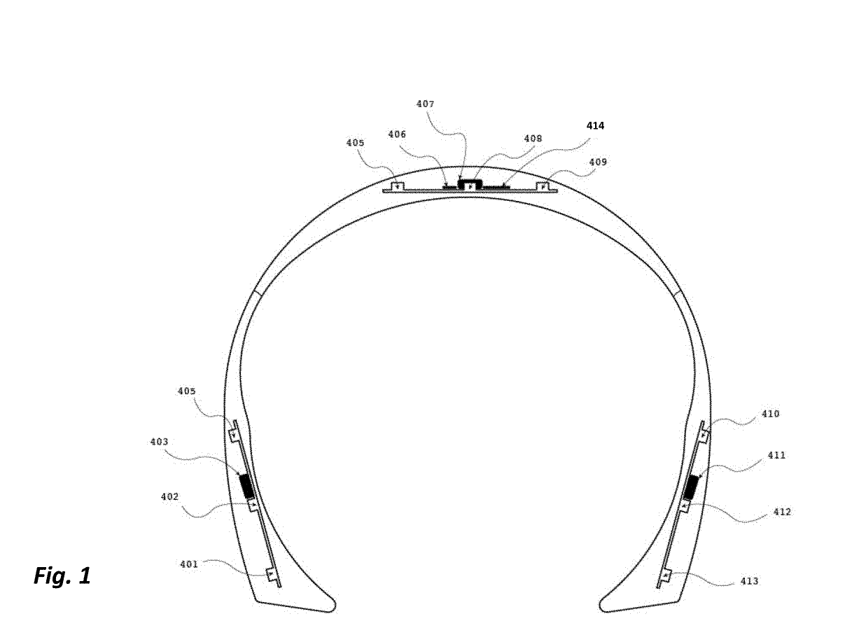

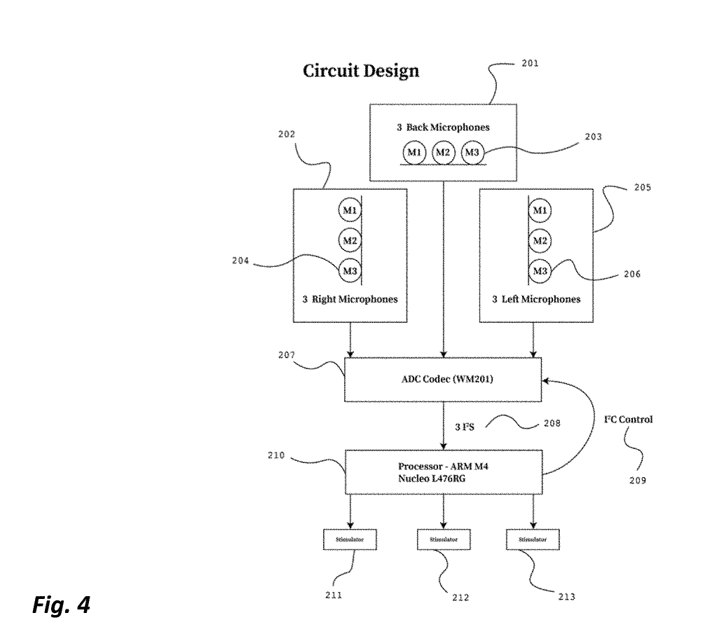

FIG. 1 shows a top view of a wearable auditory feedback device, according to some embodiments. The wearable auditory feedback device is a combination of one or more microphone array, with microphone array comprising one or more microphones. Microphones 401, 402, and 405 are each microphones in one, linear, microphone array. Microphones 405, 408, and 409 are a second set of microphone arrays which would be worn on the back of the user's neck in the embodiment shown. Microphones 410, 412, and 413 are the third set of microphone arrays in the shown embodiment. To display the audio data that is chosen by the rules of the program, vibration motors 407, 403, and 411 provide tactile feedback based upon the direction of the sound. Additionally, the wearable auditory feedback device includes a processor 406, as described in more detail below with respect to FIG. 4.

In some embodiments, the wearable auditory feedback device includes a non-volatile computer readable medium 414 which stores a plurality of settings for configuring, for example, the microphone arrays, feedback motors, processor or other components of the wearable auditory feedback device. This non-volatile computer readable medium may be, for example, a Secure Digital (SD) memory card. A user can update the settings by directly updating the non-volatile computer readable medium. For example, to continue with the SD memory card example, the user may remove the card and update it with another computing device. When the card is replaced in the wearable auditory feedback device, the new settings may be automatically detected by the processor and take effect. In other embodiments, the new settings may be received via a wired or wireless network interface such as a Bluetooth wireless module. For example, in one embodiment, the new settings may be received from/to a hearing aid, cochlear implant, or other hearing device. Alternatively, the settings may be received over the network from a computing device such as the user's smartphone. In some embodiments, the network interface is in the same physical component as the non-volatile computer readable medium 414; while, in other embodiments, the network interface may be in a separate component (not shown in FIG. 1).

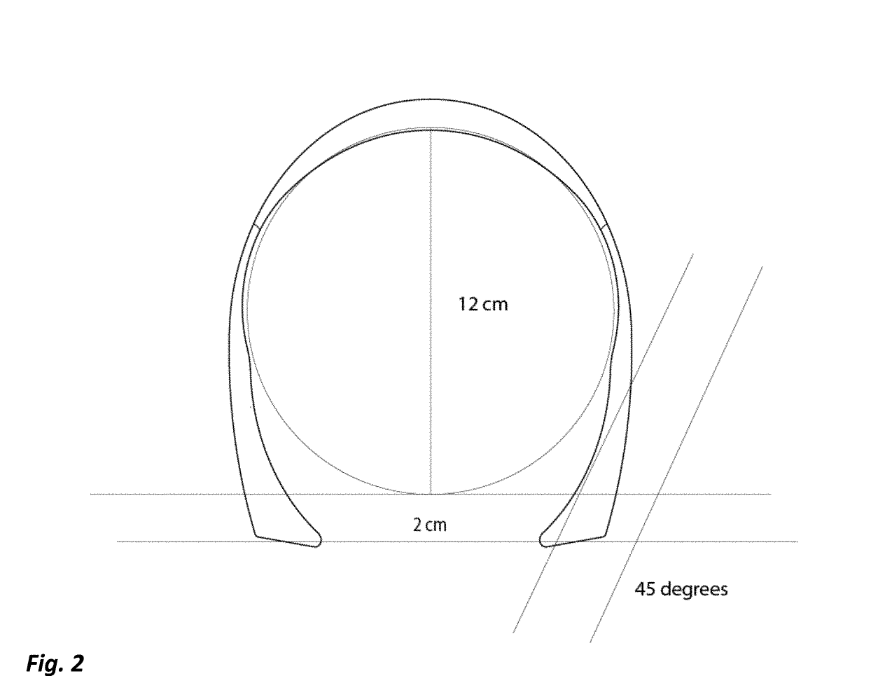

The wearable auditory feedback device includes one or more batteries (not shown in FIG. 1) used to power the various electronic components of the device. In some embodiments, these batteries may be recharged using a standardized connection (e.g., USB) to an electrical outlet. Kinetic Energy Harvesting may also be used to improve battery life and sustainability of the wearable auditory feedback device. Kinetic Energy Harvesting uses the movement of the user wearing the device to harvest the energy produced by their movements and enhance the life of the battery. When a child is running around at recess wearing the device, the movement is converted from kinetic energy into electrical energy to help power the device for a longer period of time. The longer the device is worn, the more power can be conserved. Movement throughout a usual day cannot, on its own, charge the device, however, combined with battery power, they can assist in prolonging the life of the batteries. FIG. 2 provides an example of dimensions of the wearable auditory feedback device, according to some embodiment.

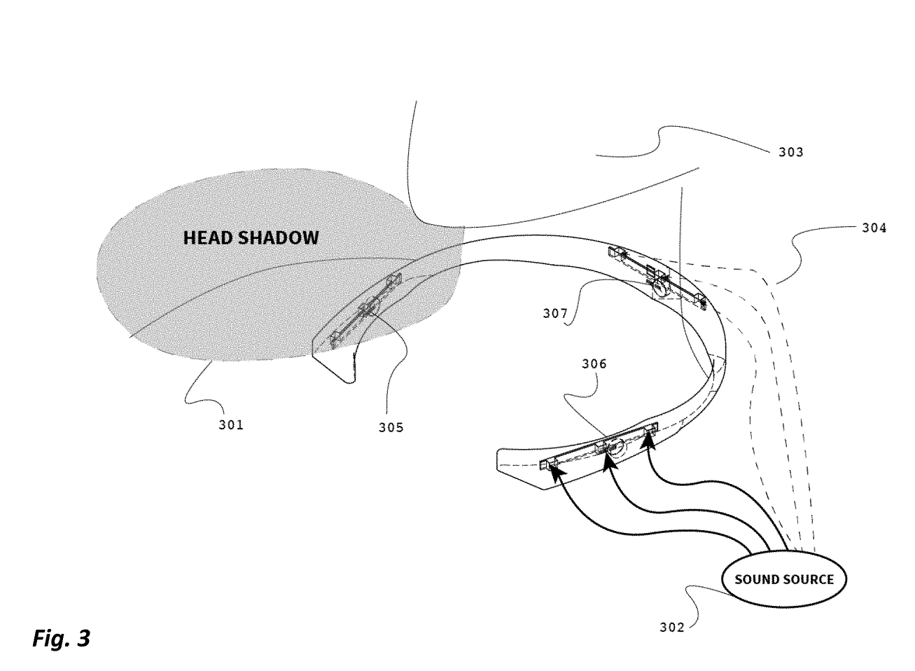

FIG. 3 illustrates the wearable auditory feedback device being worn around the user's neck, according to some embodiments. As shown in the figure, the wearable auditory feedback device includes three microphone arrays 305, 306, and 307 and a sound source 302 on the person's left. There is a shadow 301 over the right side microphone array 305. Due to the Head Related Transfer Function (HRTF) and the shadow 301 created by the head 303, there is a differentiation of sound when a sound source is mostly on one side of the person's body. As is well understood in the art, as sound strikes a listener's body, the anatomical features of the listener (e.g., size and shape of head, size and shape of ears, size and shape of nasal and oral cavities) tend to boost some frequencies, while attenuating others.

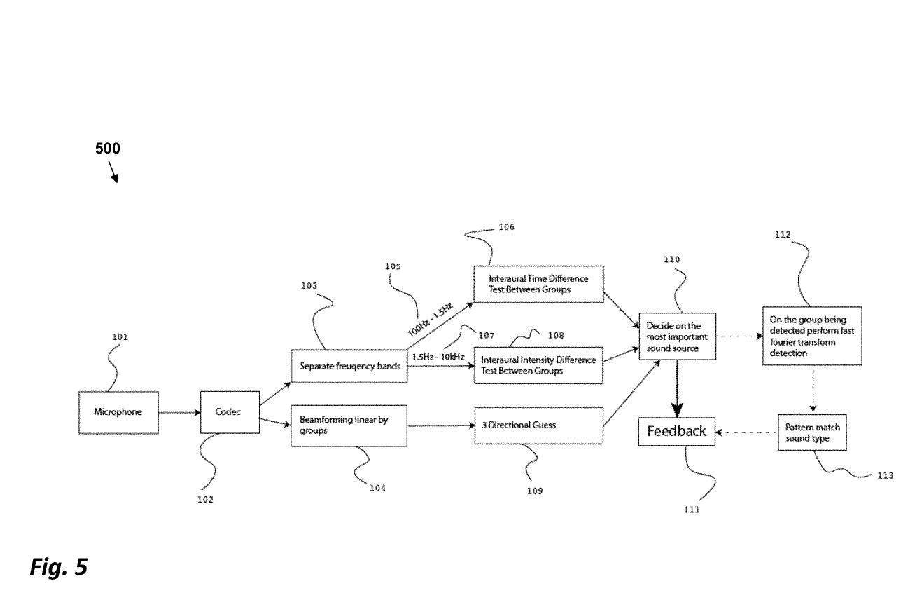

The HRTF is a response that tries to characterize this boost or attenuation of frequencies. In applications which require the knowledge of height, or elevation of sound compared to the wearable auditory feedback device, the angle at which the sound is detected and related to the microphones, can be replied via the HRTF. The external part of the ear, or the pinna, and the head change the intensity of sound frequencies. Data collected by the microphones related to the HRTF provides additional spectral cues compiled in the comparison of digital signal processing data further explained in 110 of FIG. 5

FIG. 4 provides an illustration of a circuit of the wearable auditory feedback device, according to some embodiments. The circuit in this example includes 3 sets of 3 microphone arrays. The microphones include a first array 201 of three microphones 203 at the back of the user's neck, a second array 202 of three microphones 204 at the right side of the user's neck, and a third array 205 of three microphones 206 at the left side of the user's neck. An Analog-to-Digital Converter (ADC) Codec 207 digitizes and encodes the signals acquired from the arrays 201, 202, and 205.

The digital signal 208 is sent to a processor 210 via electrical serial bus. In some embodiments, such as that illustrated in FIG. 4, a digital audio interface such as I²S may be used. The processor 210 in the example of FIG. 2 is an ARM M4 Nucleo L475RG; however, it should be understood that other processors generally known in the art may be similarly used in the circuit design.

Single linear arrays provide two angle estimations for locating sounds. The addition of multiple microphone arrays, the combination of 201, 202, and 205 provide additional sound processing to combine the algorithm in FIG. 5, combining multiple techniques of sound processing.

FIG. 5 illustrates a sound processing algorithm 100 utilized in some embodiments of the present invention. This algorithm 100 may be used to determine the important information utilizing multiple techniques of sound processing coupled with important electronics to process the information. Depending on factors such as frequencies, time delay, and beamforming, a “directional guess” is made by the software and output as Feedback 111 by the wearable auditory feedback device.

The algorithm 100 begins as a microphone array 101 captures sound waves from the environment and then converts those sound waves into electrical variations, which are then amplified. In general, any microphone known in the art may be used in the microphone array 101. However, the overall fidelity of the data will depend on the types and number of microphones in the microphone array 101. Thus, the microphone array 101 is preferably configured with a set of microphones tailored to voice detection in relatively noisy environments.

The signals captured by the microphone array 101 are next processed by a Codec 102. Any audio codec or audio processing system known in the art may be used for the variety of power efficient functionalities embedded in the chip for complex digital audio processing. Some embodiments may include having the ability to process audio with advanced noise reduction, echo cancelation, and superior enhancement of speech. Ideal microchips to be used for processing will be developed for portable audio devices. The audio codec used in 101 should also have the ability for multi-channel processing.

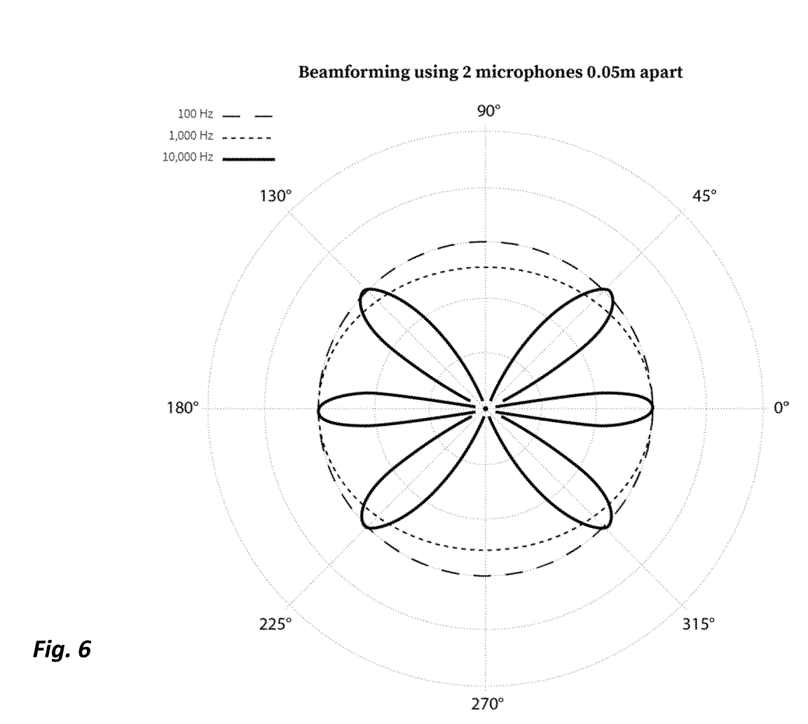

Following encoding, the frequency bands are separated at step 103. These frequency bands correspond to “low” and “high frequencies.” In the example of FIG. 1, frequencies 100 Hz-1.5 Hz (labeled 105) are designated as “low” frequencies, while frequencies between 1.5 kHz and 10 kHz (labeled 107 in FIG. 5) are designated as “high” frequencies. It should be noted that these ranges are just exemplary and other values could be used in different embodiments of the present invention. Due to the arrangement of microphones displayed in the results on beamforming in FIG. 6 at 0.05 m apart, the linear microphone arrays are beamforming, therefore any sound at a frequency of 10 kHz will go through the digital signal processing of beam forming in 104. In specific settings, different techniques for sound processing may be used to provide the ability to create different settings that focus on or filter out certain frequency ranges.

For the low frequencies 105 an inter-aural time difference (ITD) is tested between the groups. As is understood in the art, the ITD is the difference in time that it takes sound to get from the left ear to the right ear and vice versa. In this context, ITD refers to the difference in arrival time of a sound between the microphones in the microphone array 101. Based on the delay of sound arrival, ITD confirms the source of the signal between the left and the right microphones. When a head shadow is formed on one side, as shown in FIG. 3, ITD and inter-aural intensity difference (IID) are used to confirm the location of the sound source.

The ITD provides an indication of the direction or angle of a sound from the microphone array 101. Thus, it is a “localization cue” in the sense that it helps a user localize a sound source. For the high frequencies 107, an IID is tested between the groups. Like the ITD, the IID is a localization cue. By measuring the intensity between the microphones in the microphone array 101, or a combination of microphone arrays expressed in the embodiment of FIG. 4, the origin point of a sound may be determined. Additionally, in some embodiments, differences in sound level entering the ears (interaural level differences or ILD) may be considered. Techniques for measuring ITD, IID, and ILD are generally known in the art and may be applied at steps 106 and 108 to determine the relevant measurements. Because of the head shadow, low frequencies are not affected by ILD/IID.

As an additional localization cue, beamforming is performed linearly for groups of frequencies at step 104 to determine which microphone is picking up the sounds. FIG. 6 illustrates how beam forming may be performed using two microphones 0.05 m apart, according to some embodiments. Beamforming uses phase delay to detect the angle, therefore, the distance between each microphone in a single array should be smaller than the wavelength. Depending on the distance to the sound source and the frequency of the sound, different sound beams are formed. When multiple microphones are put into the formation of an array, the distance between each microphone affects the sound beams that are formed. Beamforming depends on the spacing distance of the microphones. If the sound source is far enough, the Delta sum beamforming principle can be used to determine the sound source location. Using beamforming alone will not provide high accuracy, thus it is combined with ITD and BD to create confirmation of the origination location of the sound. Also, a user's head shadow (see FIG. 3) blocks the beamforming. ITD and ILD are used confirm the direction by their detection of the important sound location.

Returning to FIG. 5, at step 109, a 3-Directional Guess algorithm is executed to predict a direction based on the beamforming data. As known in the art, a beamformer pattern is a way to make a group of omni-directional microphones directional by mixing their signals using some range of a frequency domain. The range of this domain impacts the signals magnitude and delay the signal. The algorithm uses this delay sum beamformer to delay different signals together to form a beam which can be visualized through computer test programing in FIG. 6. The following factors are used to calculate the delay sum beamforming: the spacing between microphone elements (l), the speed of sound (c), the signal frequency of the sound (f) and an integer (n) which selects the grafting lobe of the beam formation. This algorithm is then taken and ‘steered’ through adapting the ranges in the direction in which we want to find a sound source.

The direction of sound is determined based off of the user's point of view relative to the wearable auditory feedback device. Thus, the front of the wearable auditory feedback device preferably remains the front and not be turned around to the back. The right of the wearable auditory feedback device preferably remains on the right side of the user and vice versa for the left. When this is done, the user's point of view and the sound direction can remain constant. The point of view of the person is relative to how they turn. When the right side remains constant with the wearer's right side, the direction of sound can accurately determine which side of the user the sound source is on when they turn in different directions.

At step 110, the ITD, IID, and the 3-Directional Guess are used to decide on the most important sound source. The data from all applied digital sound processing techniques are compared in the processor. Upon processing, the data that is most important depends upon the coding of the algorithm in which important frequencies, sound intensities, and picked up signals via beamforming are determined per the application.

Once the sound source is determined, Feedback 111 is provided to a user to locate where a sound is coming from. For example, when the sound source is coming from the right side of the user and is within predetermined proximity, the user may feel a vibration to their right, where the wearable auditory feedback device makes contact with their body. Where a display is provided (e.g., where the device is integrated with smart glasses), a visual indicator may be provided indicating the direction of sound and possibly an indication of the speaker.

With vibration, visually impaired users strengthen their sense of touch through feeling and understanding the nature and proximity of sound. In some embodiments, the apparatus can vibrate at different patterns to represent what the sound is and how far away the sound is. For example, once the direction of the source of the sound has been detected. The distance to the source may be estimated. Then, based on this distance, a particular pattern can then be selected and used in activation of the vibration motor. For example, the intensity of tactile vibration would be higher for a close sound source than for a distant sound source.

Optionally, at step 112, a Fast Fourier Transformation (FFT) is performed on the group detected and at step 113, pattern matching is performed. Fast Fourier transformation adjusts data collected in the time domain to convert into the frequency domain. For example, if the important sound data collected is that collected by the ITD and, requires a comparison or pattern matching with the IID, the comparable data must be acquired and both sets of data need to be recognized in the frequency domain. If the important data collected by the ITD, IID, and Beamforming are all collected in the frequency domain, FFT is not needed and therefore step 112 and 113 are bypassed.

FIG. 6 displays the results of tests completed with beamforming that utilize microphones that are 0.05 m apart in some embodiments. With this distance used, sound sourcing beams are formed at frequencies around 10 kHz. To use beamforming in the algorithm of the wearable device, the distance between each microphone must be smaller than the wavelength in order to prevent aliasing, or indistinguishable sounds.

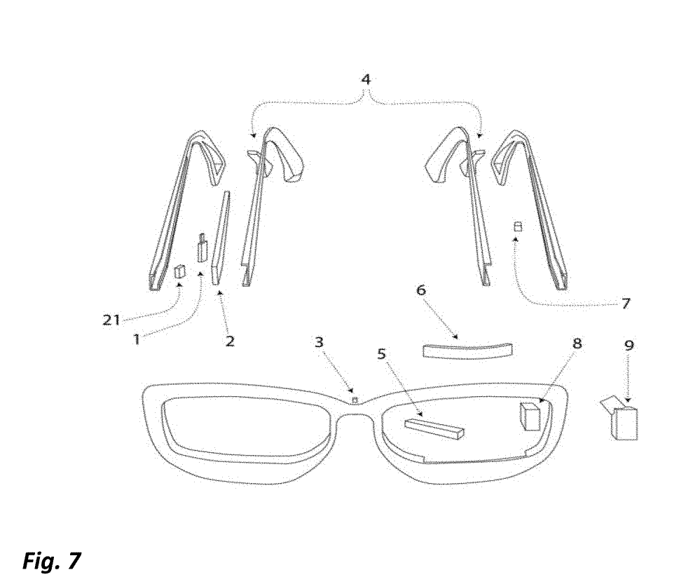

FIG. 7 shows a view of the wearable auditory feedback device integrated with smart glasses, according to some embodiments. There are three items embedded in the right arm of the glasses: a tactile control 1 (e.g., roller ball), a circuit board 2, and a power control 21. A microphone array 7 is embedded in the left arm of the glasses. Two batteries 4 are embedded in the rear portion of the arms of the glasses. In the front portion of the glasses, a display projector 9 (e.g., a virtual retinal display using a Digital Light Processing projector) displays information for the user to view. A mirror 5 reflects the display in the bottom half of the user's eye to appear as if it is hovering. The angle at which the mirror is effects the location of the display. Camera 8 (e.g., an AREMAC Camera) reflects the projected display from the display projector 9 on to the mirror and into the user's eye. A transparent, non-reflective component 6 covers the inner skeleton of the glasses to protect the hardware. This component is sonic welded to the exterior of the frames. The front portion of the glasses includes another microphone 3.

Using the display of the smart glasses, a directional indicator may be presented to the user indicating the direction of the originating location of a sound. The directional indicator may be presented in graphic form, as a symbol or shape that shows where the direction of sound is and may rotate around the user according to their front plane, side plan, or sagittal plane. The directional indicator can also move with the user and maintain their understanding of their environment. The dynamic movement of sound can be controlled by an accelerometer of gyroscope for in-sync movement of the sound as the person wearing the microphone array turns and moves in the graphic of a display.

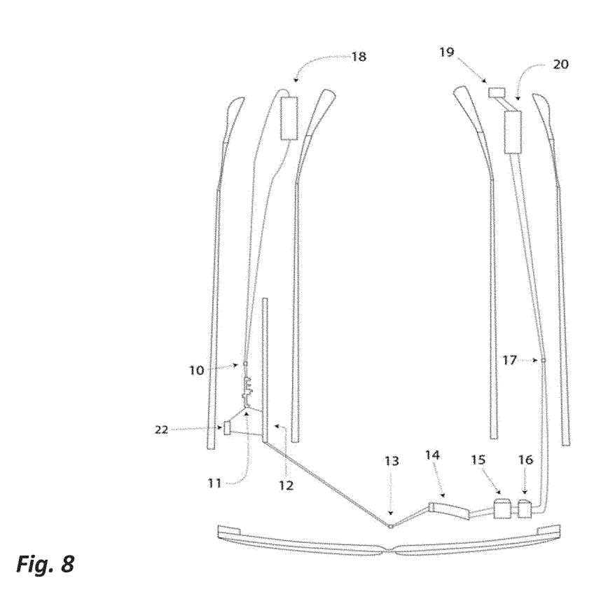

FIG. 8 provides a second view of the auditory feedback device integrated with glasses, according to some embodiments. The right arm of the glasses and the left arm of the glasses include microphone arrays 10 and 17, respectively. An additional microphone array 13 is in the front portion of the glasses. There are three items embedded in the right arm of the glasses: a tactile control 11, a circuit board 12, and a power control 22. The front portion of the glasses includes the mirror 14, camera 15, and display projector 16. Batteries 18 and 20 are in the rear portion of each arm of the glasses. This view also shows a charging port 19 connected to battery 20. This charging port 19 may be, for example, a micro-USB connector, a lighting connector, or any similar connector generally known in the art.

In some embodiments where the auditory feedback device is paired with smart glasses, an accelerometer and gyroscope can also be used to control the features of the glasses. By nodding up or to the left or right, the user can scroll through captions, features, and settings. Each of these adjustments could also be controlled by the aforementioned technical component controls.

When connected to a heads up wearable display, the interfaces of the display is located on the bottom half of the lens. Thus, the user is able see the captions while using their peripheral vision to maintain attention to what is happening around them. The user can maintain their focus forward and keep better eye contact with the person(s) with whom they are communicating. In some embodiments, the text on an integrated heads up display is contrasted by a background color with a transparency so objects beyond the display can be seen but a user with full functioning color vision does not have to strain their eyes to see the text. This text is similar to that of captioning on a television screen—white text on a black background. In some embodiments, the wearable auditory feedback device display uses a background of different transparency to enhance optical use.

Additionally, colors may be selected for the integration of a heads up display and can exhibit a minimal amount of blue light in order to support research on health concerns eluding that blue light suppresses melatonin and prolonged exposure can lead to insomnia or other health concerns. The amount of blue light exposure can be automatically adjusted through a photo-resistor (or the camera) included in the wearable auditory feedback device that uses an input for the amount of light exposure outside to adjust the output of the amount of blue light projected on the display. In some embodiments, the photo-resistor uses light exposure to attempt to calculate what time of day it is. If the resistor is exposed to more light, it is assumed it is day time and therefore blue light could supposedly help suppress melatonin and thus the user is assumed to be more awake. Vice versa is true for less exposure to light. It is assumed it is night time and blue light exposure is decreased so that melatonin is not suppressed.

In some embodiments, a camera in the smart glasses pointing downward and outward toward the wearer's hands converts gestures to text or spoken word. Gesture recognition will assist for persons that know sign language but do not speak English or another spoken language. Being in the bottom, the camera can see the user's hands. This camera could be a wide angle lens in order to capture the whole sign language. Proper security settings within the programming code will protect the user's privacy.

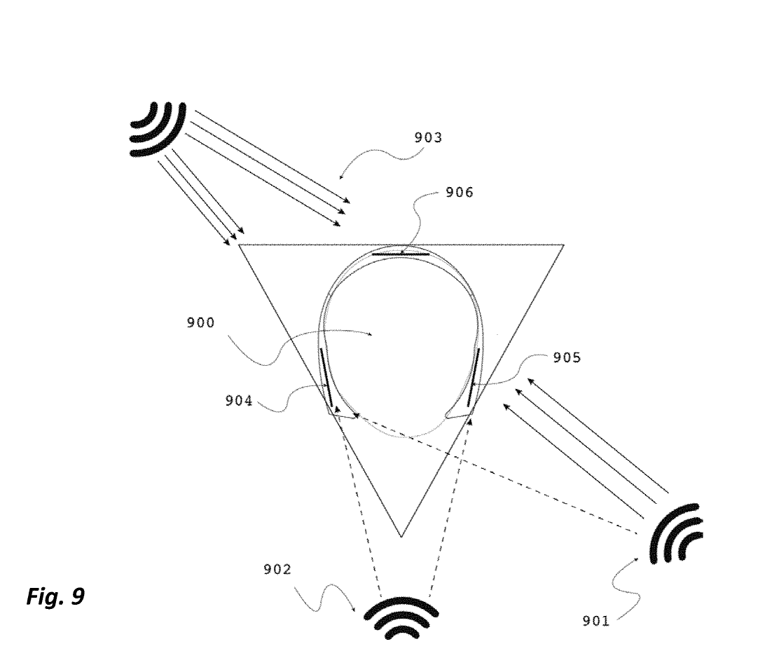

FIG. 9 provides an example head related transfer function and how the combination of sound processing techniques is used with sounds sourced from some different areas in a space, according to some embodiments. The sound coming in from location 902 represents the challenge of only using the beamforming because the beams formed by the right microphone array 904 (see microphones 401, 405, and 402 in FIG. 1) and the left microphone array 905 (see microphones 410, 412, and 413 in FIG. 1) will form the same angle of a beam but in opposite directions. Therefore, with the addition of the ITD, the guess of an equal delay or difference in delay close to zero will indicate that sounds from location 902 are originating from in front of the user.

Continuing with reference to FIG. 9, the center of the user's head is located at location 900. For a sound source originating from location 901, the left microphone array 905 may provide two guesses of angles using beamforming. Then, the determination may be performed through ITD and IID. The right microphone array 904 will have a difference in the time delay and the rear microphone array at 906 will have a lower intensity due to the head shadow described in FIG. 3. A sound source from location 903 will have a time delay between the rear microphone array at 906 and right microphone array 904 which provides the positioning of the sound through the processing of the code. The signal of the left microphone array 905 will be of a lower intensity due to the aforementioned head shadow effect.

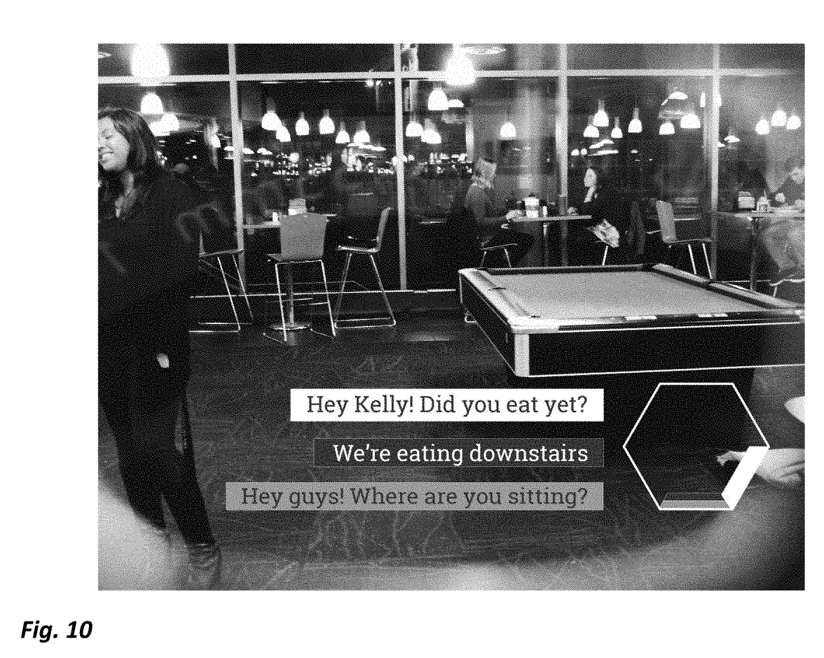

FIG. 10 shows how text captions can be displayed on the auditory feedback device, when integrated with smart glasses. In the example of FIG. 10, the text is shown at the bottom of the display, overlaid on real-world viewing area. Here are three speakers shown, as denoted by the different shadings: speaker I is stating “Hey Kelly! Did you eat yet?”, speaker II is stating “We're eating downstairs”, and speaker III is stating “Hey guys! Where are you sitting?”. The example of FIG. 10 is a black and white rendering of the display and it should be understood that an implementation of the auditory feedback device may utilize different colors or other visual indicators to denote different speakers, rather than shading. FIG. 10 also shows a hexagon in the bottom right hand portion of the image that provides an indication of each speaker's direction with respect to the user of the auditory feedback device. Blocks along each edge of the hexagon indicate the speaker's directions. The shading or color of each block corresponds to the speaker's shading or color shown in the text. Thus, speaker I is located southeast of the user, while speakers II and III are located south of the user.

In some embodiments, the wearable auditory feedback device saves captions for personal use and offers additional ways to take notes and remember information. Saving of the caption data may take place locally within the device or using an external storage device. The captioning may be transferred over to a computing device (e.g., smart phone) or computer application via Bluetooth, Wi-Fi, USB, or a similar communication medium. In one embodiment, captions are stored in cloud-based system. This system may allow the user to review their saved captions through multiple devices and encompass a larger memory than that is capable on the memory board of the device itself.

In some embodiments, captions can be edited. Machine learning can be used improve the accuracy of captions by editing the inaccurate captions. For example, captions can be corrected so that machine learning of the voice to text system can implement more accurate captioning when that same voice is transcribed. People providing corrections to the captioning may be but are not limited to, the student, their peer, another user, a parent, a sibling, a teacher, or the company maintaining the software or one of their partners.

Integration of the auditory feedback device with smart glasses has the added benefit that it helps people with ADHD to pay attention for longer periods of time. When doing more than one thing at a time, people with a certain spectrum of ADHD are able to maintain attention for a longer period of time. Smart glasses with captioning help people with ADHD to retain more information. People with ADHD are able to maintain attention and providing a visual method to obtain information. The user is able to refer back to captions and recall information at a later date.

Quality recordings give the sound algorithm better accuracy at detecting the sound direction. Additional user recordings may be integrated with the voice-to-text algorithms to learn and improve the accuracy of voice recognition over time. Additionally, in some embodiments, machine learning models such as neural networks can be used for voice-to-text translation (using voice as an input to the model and text as an output). If the user makes any correction to the text, those corrections can be used as feedback into the machine learning model to increase its accuracy for future translations.

The captions taken in an educational lesson can be used to help take accurate notes that a student didn't have enough time to write down, or a deaf or hard of hearing student may have missed due to auditory fatigue or misinterpreting a word. Users can now pay more attention to what their teachers, peers, or other people with whom they are communicating, are saying rather than concentrating on writing information down. The users will be able to refer to and recall more information because they are putting their full attention on learning and not attempting to multi task.

The captioning system discussed above can be used to improve attention problems including, but not limited to, Attention Deficit Disorder, Auditory Fatigue, day dreaming, and hearing impairments. By saving and documenting information converted from voice to text, the wearable auditory feedback device described herein provides an ‘extension of their memory’. For example, where the device is integrated with smart glasses, users that are experiencing auditory or reading fatigue will be able to scroll through or refer back to captioning so they are still able to receive and recall information that they may have missed. The sound localization techniques described herein also assist in limiting auditory fatigue because the user will have improved response to where a question is being asked or where the next speaker is. This improved response time will assist with other necessary visual cues for communication.

As in normal hearing capabilities, humans cannot typically hear voices across a large room. Therefore, in some embodiments, rooms may be configured with a centralized microphone, referred to herein as a “beacon.” Users of the wearable auditory feedback device can connect with the beacon to receive additional auditory information about the environment. The beacon can also send the voice information to process and output amplified sound through compatible hearing devices. To reduce the echo between individual wearable microphones, the beacon can be used with the wearable auditory feedback device as the primary microphone. The beacon can be used in group presentation situations (e.g., work meetings, conferences, or school lectures) and the microphone in the beacon will only be used for sound localization. Captioning text and sound sent to a hearing device are done through the external hub. The individual devices are not able to process voice recognition.

In some embodiments, the wearable auditory feedback device is connected to a smartphone, tablet, smart watch, or similar mobile device. The connection between the wearable auditory feedback device and the mobile device can be wireless or wired. For example, in some embodiments, the wearable auditory feedback device and the mobile device communicate via the Bluetooth protocol. On the mobile device, one or more apps may be used to interact with the wearable auditory feedback device. For example, the apps may allow the user to change settings of the wearable auditory feedback device (e.g., set the mode of each microphone to decide which microphones in the wearable are processing sound). The apps may also allow the user to view, edit, and share transcription files previously generated using the captioning functionality described above. In some embodiments, the apps allow the user to select necessary and relevant information from the transcripts and sort them into “note” folders which can be sorted based on any category, for example—“American History” which could have a subfolder of “George Washington” and so on. This could also be accomplished automatically by importing a schedule that corresponds with captioning (e.g., via a calendar app on the mobile device). Additionally, the display of the mobile device may be used as supplement or alternative to the smart glasses version of the wearable auditory feedback device. For example, in configurations of the wearable auditory feedback device that do not include smart glasses (e.g., see FIG. 1), the screen of the mobile device can be used to display captioning, directional information, etc.

The integration of a laptop, tablet, or mobile phone may be necessary for an educational environment due to the use of visuals. If the wearable auditory feedback device is integrated with a heads up display, there can be an option to view captions on another screen and turn off the heads up display. When the text is overlapping with the visuals, a presenter is experiences confusion and the attention span of the user is hindered by trying to focus on meshed visuals. When using the around-the-neck configuration of the wearable auditory feedback device, connected with computers, tablets, or other displays that are already used in the classroom, the user can integrate their sound localization with the words being said in caption form. The user can choose what is seen on the application. They are able to open the location graphic and/or the captioning simultaneously or individually.

The wearable auditory feedback device described herein may be used to automate and collect data for recognition of lessons and conversation. For example, data can be collected from the accuracy of captioning classroom lessons, associating the amount of mark-ups, clicks, and attention the user gave those captions and comparing their grades. The accuracy of the captions can also be compared to see how that affects the user's educational progress. Additional education features can provide educational institutions information based off individual progress. Special education Individualized Education Program (IEP) can be based off of some of the data collected through the application. This data can be used to see how their institutions are helping students to progress in coursework—especially within special education where personalization for each student is important.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

The functions and process steps herein may be performed automatically or wholly or partially in response to user command. An activity (including a step) performed automatically is performed in response to one or more executable instructions or device operation without user direct initiation of the activity.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers and processes can be implemented using hardware components, software components, and/or combinations thereof. No claim element herein is to be construed under the provisions of 35 U.S.C. 112, sixth paragraph, unless the element is expressly recited using the phrase “means for.”

1. A wearable auditory feedback device comprising:
a frame wearable on a user's head or neck;
a plurality of microphone arrays embedded in the frame on a left side, a right side, and a rear side with respect to the user;
a plurality of feedback motors embedded in the frame on the left side, the right side, and the rear side with respect to the user; and
a processor configured to:
receive a plurality of sound waves collected with the microphone arrays from a sound wave source,
determine an originating direction of the sound waves, and
activate a feedback motor on a side the frame corresponding to the originating direction.

2. The wearable auditory feedback device of claim 1, the processor is further configured to:
estimate a distance to an originating source of the sound waves,
select a vibration pattern based on the distance;
wherein the activation of the feedback motor vibrates the feedback motor according to the vibration pattern.

3. The method of claim 2, wherein originating source of the sound waves is estimated based on a plurality of locality cues corresponding to the sound waves comprising one or more of inter-aural time difference (ITD), an inter-aural intensity difference (IID), and beamforming results.

4. The wearable auditory feedback device of claim 1, further comprising:
a non-volatile computer readable medium storing a plurality of settings for configuring one or more of the plurality of microphone arrays, the plurality of feedback motors, or the processor.

5. The wearable auditory feedback device of claim 4, wherein the processor is further configured to:
receive new settings via a network connection to a hearing device; and
store the new settings on the non-volatile computer readable medium.

6. The method of claim 5, wherein the network connection comprises one of a Bluetooth or Tele-coil network connection.

7. The method of claim 5, wherein the hearing device comprises one of a hearing aid or cochlear implant.

8. The wearable auditory feedback device of claim 4, wherein the plurality of settings comprises a setting which filters the plurality of sound waves collected with the microphone arrays to attenuate sound wave frequencies outside a range of frequencies corresponding to human voices.

9. The wearable auditory feedback device of claim 1, wherein the processor is further configured to:
transmit the filtered sound waves via the network connection to a hearing device.

10. A wearable auditory feedback device comprising:
a frame wearable on a user's head or neck;
a display connected to the frame and viewable by the user as the wearable auditory feedback device is worn;
a plurality of microphone arrays embedded in the frame on a left side, a right side, and a rear side with respect to the user; and
a processor configured to:
receive a plurality of sound waves collected with the microphone arrays,
determine an originating direction of the sound waves with respect to the user, and
provide a visual indication of the originating direction on the display.

11. The wearable auditory feedback device of claim 10, further comprising:
an orientation sensor configured to determine updates to the user's orientation with respect to the sound wave source,
wherein the processor is further configured to:
determine an updated originating direction of the sound waves with respect to the user based on the updates to the user's orientation determined by the orientation sensor, and
update the visual indication of the originating direction on the display.

12. The wearable auditory feedback device of claim 11, wherein the orientation sensor is a gyroscope.

13. The wearable auditory feedback device of claim 11, wherein the orientation sensor is an accelerometer.

14. The wearable auditory feedback device of claim 10, wherein the processor is further configured to:
translate speech in the sound waves to text;
present the text on the display.

15. The wearable auditory feedback device of claim 14, wherein the text is presented on a portion of the display corresponding to the originating direction.

16. The method of claim 14, wherein the speech and originating direction correspond to a person's voice and wherein the processor is further configured to:
determine an updated originating direction of the sound waves with respect to the user, and
update placement of the text on the display based on the updated originating direction.

17. The wearable auditory feedback device of claim 10, wherein the processor is further configured to:
translate speech in the sound waves to text;
present the text on an external display connected to the wearable auditory feedback device via one or more networks.

18. The wearable auditory feedback device of claim 10, further comprising:
a non-volatile computer readable medium storing a plurality of settings for configuring one or more of the plurality of microphone arrays, the display, or the processor.

19. The wearable auditory feedback device of claim 18, wherein the processor is further configured to:
receive new settings from an external computing device via a network connection; and
store the new settings on the non-volatile computer readable medium.

20. A wearable auditory feedback device comprising:
a frame wearable on a user's head or neck;
a network interface to an external computing device comprising a display;
a plurality of microphone arrays embedded in the frame on a left side, a right side, and a rear side with respect to the user; and
a processor configured to:
receive a plurality of sound waves collected with the microphone arrays,
determine an originating direction of the sound waves with respect to the user, and
provide a visual indication of the originating direction on the display of external computing device via the network interface.
